(19) United States
(12) Patent Application Publication
(10) Pub. No.: US 2025/0346144 A1
(43) Pub. Date: Nov. 13, 2025

(54) SYSTEMS AND METHODS FOR GEOFENCE-BASED INDUCTION CHARGING

(71) Applicant: Wells Fargo Bank, N.A., San Francisco, CA (US)

(72) Inventors: Rameshchandra Bhaskar Ketharaju, Hyderabad (IN); Rishik Reddy, Hyderabad (IN)

(21) Appl. No.: 18/658,320

(22) Filed: May 8, 2024

(51) Int. Cl. B60L 53/66; B60L 53/12; B60L 53/38; B60L 53/65; G06Q 20/36; G06Q 20/40; G06Q 20/42

(52) U.S. Cl. CPC B60L 53/665; B60L 53/12; B60L 53/38; B60L 53/65; G06Q 20/3672; G06Q 20/40155; G06Q 20/42

(57) ABSTRACT

Systems, apparatuses, methods, and computer program products are disclosed for geofence-based induction charging system. An example method includes identifying an EV by validating vehicle parameters using vehicle identification circuitry and identifying a geofence charging area by comparing vehicle geolocation data with geofence area data using geofence circuitry. The example method further includes generating an entry token and an exit token for the EV using token generation circuitry, and generating a charging transaction for the EV based on the entry token and the exit token using payment transaction circuitry. The entry token comprises at least one or more of a vehicle identifier, an entry timestamp, an entry location, or an entry power level, and the exit token comprises at least one or more of the vehicle identifier, an exit timestamp, an exit location, an updated self-charging rate, an updated power consumption rate, or an exit power level.

### BACKGROUND

Electric vehicles (EVs) are automobiles, or other vehicles, that use an electric motor for propulsion. Most EVs are powered by electricity stored in onboard rechargeable batteries. Some EVs, also known as hybrids, can be powered by electricity generated by an onboard generator which converts fuel to electricity and charges onboard batteries. The onboard batteries of an EV can be charged by plugging the EV into a power station when parked. Induction charging is a type of wireless charging that uses electromagnetic induction to provide electricity to electrical devices without the use of a power cord tethering the electrical device to the power supply.

### BRIEF SUMMARY

With the increasing popularity of electrical vehicles (EVs), many focuses have been shifted to design a revolutionary EV charging infrastructure to significantly improve charging convenience, efficiency, and sustainability. Geofence-based induction charging system, a futuristic EV charging infrastructure, has gained a significant attraction. Geofence-based charging may integrate wireless charging technology (e.g., induction charging, radio frequency (RF) wireless charging, and/or resonance charging) into designated geographic areas (“geofences”) to enable EVs to charge their batteries either while stationary (e.g., parked, stopped, etc.) and/or while in motion (e.g., driving) within the induction charging areas. The geofences may be created as virtual boundaries around any geographic locations, such as a rest area, a parking lot, a garage, along a highway and/or the like as described herein. In some examples, a geofence may be defined around an area using Global Positioning System (GPS) coordinates, cell tower trilateration and/or triangulation positioning, Radio-frequency Identification (RFID) technologies, and/or any other geolocation technologies and/or techniques as described herein. With induction charging, electromagnetic fields are employed to transfer energy wirelessly from a charging pad or coil embedded under the ground directly or through an induction tower that houses power electronics and control systems to a receiving equipment installed on the EV. When an EV equipped with induction charging technology enters a geofence charging area, the induction charging system detects the presence of compatible EVs and the charging process may automatically initiate without human intervention of connecting physical cables or plugs. Therefore, EVs may be charged while travelling to the destination without a need to stop at a charging station, making the charging experience more convenient and user-friendly. In addition, geofence-based induction charging provides great sustainability and environmental benefits, as the geofence-based induction charging system may utilize renewable energy efficiently, such as solar power and wind power.

As a result, establishing a geofence-based induction charging system to provide induction charging to EVs, and at the same time dynamically monitor the charging, accurately generate and automatically process the charging transactions, customized for each individual EV to accommodate for different vehicle parameters and charging characteristics, is essential to embrace the widespread adoption of EVs in the near future. However, accurately determining the power received by (or transferred to) an EV within the geofence charging area may be difficult because the EV, while actively charging, may be simultaneously consuming power and at least partially self-charging while traveling through the charging area. The power consumption rate and self-charging rate may be variable depending on the travel speed of the EV. Different EVs may be equipped with, among other things, different types of batteries and/or charge controllers, each having different charging capabilities. Accordingly, multiple charging factors need to be taken into consideration, such as the vehicle model (which may determine the self-charging rate and power consumption rate at different travel speeds), the battery type, travel time within the geofence charging area, and/or the charging mode (e.g., stationary or in motion charging). In addition, a geofence charging area may include multiple charging lanes and/or zones each associated with one or more respective charging speeds (e.g., a cruising speed, a range of speeds, etc.), one or more charging rates, and/or one or more charging sources (e.g., power grid, charging pad, solar panels, wind turbines, and/or the like as described herein). For example, an EV battery system may have multiple battery cells and, in some such examples, each cell may be charged (e.g., simultaneously) from a respective charging source.

Traditionally, it has been difficult to take into account all of the charging factors in order to determine an accurate charging transaction reflecting the actual power (e.g., electricity, current, etc.) received by, transferred to, and/or generated by, an EV while in motion. Conventional approaches include (1) determining the charging transaction by detecting the power transferred to an EV by one or more charging sources, such as charging pads embedded under the highway, or (2) capturing the charging time and then multiply the charging time by a fixed pre-defined charging rate. In the first approach, in order to calculate an accurate charging transaction, the accuracy of the detection of the transferred power needs to be high which may be difficult to achieve, especially in a highway environment when multiple EVs are traveling at high speeds and charging simultaneously. Even though the transferred power may be accurately detected, the actual amount of power received by each individual EV may not be equal to the transferred power, because the amount of the received power may depend on the vehicle model, the battery type, the driving condition (e.g., terrain, weather, and temperature), the driving style, and etc. In the second approach, applying a fixed pre-defined charging rate without considering other factors such as the power consumption rate and self-charging rate may result in a significantly under-estimated or over-estimated charging transaction. Therefore, establishing a geofence-based induction charging system (as described herein) that can accurately generate and automatically process the charging transactions may have many advantages to accommodate for the widespread adoption of EVs in the near future.

In contrast to these conventional techniques for processing charging transactions, example embodiments described herein provide a geofence-based induction charging system that may first identify an EV entering a geofence charging area by validating vehicle parameters. The vehicle parameters may comprise at least one or more of a vehicle identifier, a user account or billable account, a vehicle model, a battery type, a charging mode, a power consumption rate, or a self-charging rate. The geofence-based induction charging system may further identify a geofence charging area by receiving vehicle geolocation data from the EV comprising one or more of a location of an RFID scanner, a license plate camera, vehicle GPS data, a direction of travel, or a travel speed and remotely guide the EV to a selected charging lane/zone to start charging with a respective charging speed, charging rate and charge source. In some examples, the geofence-based induction charging system may generate an entry token and an exit token in response to the EV entering or exiting the geofence charging area, wherein the entry token comprises at least one or more of a vehicle identifier, an entry timestamp, an entry location, or an entry power level and the exit token comprises at least one or more of the vehicle identifier, an exit timestamp, an exit location, an updated power consumption rate, an updated self-charging rate, or an exit power level. At the time instance the EV exits the geofence charging area, based on the entry and exit token, the geofence-based induction charging system may generate a charging transaction and then process the charging transaction using a payment option selected by the EV. Finally, the geofence-based induction charging system may transmit to the EV a payment confirmation if the payment of the charging transaction is successful or a payment failure if the payment of the charging transaction is unsuccessful.

Accordingly, the present disclosure sets forth systems, methods, and apparatuses for dynamically monitoring, accurately generating and automatically processing the charging transactions of a geofence-based induction charging. There are many advantages of these and other embodiments described herein over the conventional systems described above.

One advantage is that example embodiments are capable of generating charging transactions with high accuracy by customizing each charging transaction based on different vehicle parameters such as vehicle model and battery type. In addition, the power consumption rate and self-charging rate, instead of being neglected as in traditional approaches, are taken into full consideration and may be variable depending on the EV travel speed within the geofence charging area. The difference between the entry power level and exit power level is more accurately captured by example embodiments described herein than conventional systems. Thus, example embodiments provide charging transactions with higher accuracy than traditional approaches, reflecting the actual induction charging received within the geofence charging area, customized for each individual EV.

Another advantage is that example embodiments process charging transactions in real-time (or near-real-time) (e.g., when an EV exits the geofence charging area) and provide flexibility in the selection of payment options (e.g., by passengers). In contrast, traditional charging and payment technologies may reuse toll gantries to process accumulated charging transactions simultaneously with a toll fee when an EV passes a toll gantry, thus, the charging transactions may not be processed in real-time (or near-real-time) until the EV passes a toll gantry. In addition, the toll gantries may be set up at certain fixed geolocations (e.g., exits of highways), therefore, the charging transactions processing may be limited to those fixed geolocations only. Moreover, most toll gantries require a driver/user to have a prepaid account on file which must be used for all toll gantry related fees and thus may not provide flexibility to allow EV user(s) (e.g., driver, passengers, vehicle owner, and/or the like as described herein) to select a payment option (e.g., split/share payment among driver and passengers). Therefore, example embodiments provide real-time (or near-real-time) payment processing which may capture any payment issues at the earliest time and provide the EV user(s) an opportunity to select a different payment option when the previous payment is not successful.

Yet another advantage is that example embodiments may accommodate different charging options. For example, the EV under charging could be either in a stationary position or in motion, which may be detected (e.g., based on GPS data and/or the like as described herein) by the geofence-based induction charging system. When the EV is stationary, the power consumption rate and self-charging rate may be automatically adjusted to become negligible. When the EV is in motion, the power consumption rate and self-charging rate may be continuously (or periodically) adjusted according to the travel speed or averaged over the time. The EV can be charged using one or more charging sources, depending on the type of battery equipped and the charging sources provided in the geofence charging area, the unit charging cost (induction charging cost for per unit of power received) may be adjusted to reflect the usage of one or more charging sources. Thus, compared with traditional approaches focusing only on one or two specific charging modes, example embodiments provide EV flexibility in selecting different charging options that may be properly handled by the geofence-based induction charging system.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for geofence-based induction charging.

FIG. 2 illustrates a schematic block diagram of example circuitry embodying a geofence-based induction charging system device that may perform various operations in accordance with some example embodiments described herein.

FIG. 3 illustrates a schematic block diagram of example circuitry embodying an EV device and/or user device that may perform various operations in accordance with some example embodiments described herein.

FIG. 4 illustrates an example flowchart for geofence-based EV charging, in accordance with some example embodiments described herein.

FIG. 5A illustrates an example flowchart for identifying an EV, in accordance with some example embodiments described herein.

FIG. 5B illustrates an example flowchart for identifying a geofence charging area, in accordance with some example embodiments described herein.

FIG. 5C illustrates an example flowchart for generating an entry token, in accordance with some example embodiments described herein.

FIG. 5D illustrates an example flowchart for generating an exit token, in accordance with some example embodiments described herein.

FIG. 5E illustrates an example flowchart for generating a charging transaction for EV, in accordance with some example embodiments described herein.

FIG. 6 illustrates another example flowchart for geofence-based induction charging, in accordance with some example embodiments described herein.

FIG. 7A illustrates an example flowchart for obtaining validation of EV, in accordance with some example embodiments described herein.

FIG. 7B illustrates an example flowchart for determining geofence charging options, in accordance with some example embodiments described herein.

FIG. 7C illustrates an example flowchart for paying for geofence-based induction charging, in accordance with some example embodiments described herein.

FIG. 8 illustrates a swim lane diagram with example operations that may be performed by components of the environment depicted in FIG. 1, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “electrical vehicle” or “EV” refers to any type of vehicle that is powered by one or more electric motors, using energy stored in rechargeable batteries and/or any other energy storage devices. The electrical vehicle may be an electric vehicle, solely powered by electric batteries, or a hybrid electric vehicle, having both an internal combustion engine (or generator) and an electric motor. Examples of electric vehicles may include, without limitation, one or more of a car, motorcycle, boat, aircraft (e.g., helicopter, plane, etc.), utility vehicle (e.g., all-terrain vehicle (ATV), golfcart, etc.), and/or any other vehicle equipped with rechargeable batteries and/or the like as described herein. In some embodiments, the terms “electrical vehicle” or “EV” may in addition refer to a computing device or control device onboard (or attached to) the EV. In some examples, the terms “electrical vehicle” or “EV” may further refer to one or more user device (e.g., associated with a driver, passenger, and/or the like as described herein) which may be associated with the EV and may be configured to perform various functions for the EV as described herein.

The term “geofence charging area” refers to a designated geographic area where EVs can wirelessly charge their batteries using electromagnetic induction technology. The geofence charging area may be implemented in various locations such as a rest area, a parking lot, a garage, or along highways. A geofence charging area may be further divided into multiple charging lanes/zones with respective charging speed, charging rate, and charging sources. A geofence charging area may further include one or more non-charging lanes for vehicles to exit the area, in certain situations such as non-compatible/unauthorized vehicle or invalid user account/billable account.

The term “power consumption rate” refers to the rate at which an EV consumes electric power (e.g., to drive a propulsion system). The power consumption rate may be measured in milliampere-hour (mAh), kilowatt-hours (kWh), and/or in any other units of power. The power consumption rate may vary depending on EV's efficiency, driving speed, driving style, driving condition (e.g., terrain, weather, temperature), and etc.

The term “self-charging rate” refers to the rate at which an EV recharges its one or more batteries through an onboard electric generation system, such as a regenerative braking system, generator, solar panel, and/or any other power generation equipment installed on the EV. The self-charging rate may be measured in milliampere-hours (mAh), kilowatt-hours (kWh), and/or in any other units of power.

The term “unit charging cost” refers to the charging cost associated with a geofence charging area or a specific geofence charging lane/zone to obtain one unit of battery power (e.g., 1 mAh, etc.). The unit charging cost may depend on the charging mode, (e.g., stationary or in motion), the number and/or type of charging sources utilized for charging, the charging speed, and/or the like as described herein. In some examples, the unit charging cost may be pre-defined for one or more geofence charging areas (e.g., by the geofence-based induction charging system).

### System Architecture

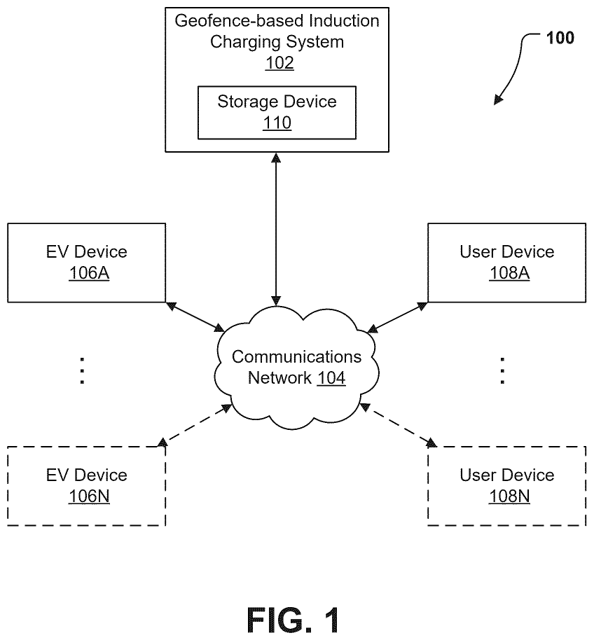

Example embodiments described herein may be implemented using any of a variety of computing devices or servers. To this end, FIG. 1 illustrates an example environment 100 within which various embodiments may operate. As illustrated, a geofence-based induction charging system 102 may receive and/or transmit information via communications network 104 (e.g., the Internet) with any number of other devices, such as one or more of EV devices 106A-106N and/or user devices 108A-108N.

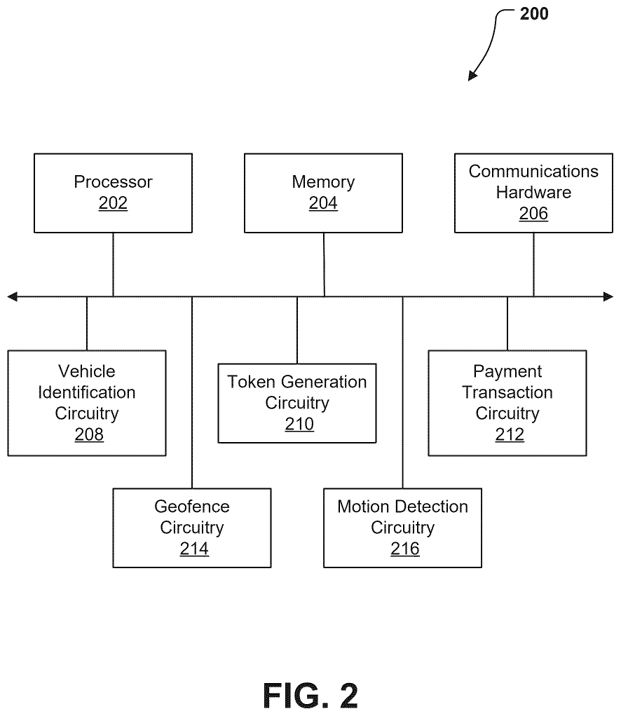

The geofence-based induction charging system 102 may be implemented as one or more computing devices or servers, which may be composed of a series of components. Particular components of the geofence-based induction charging system 102 are described in greater detail below with reference to apparatus 200 in connection with FIG. 2.

In some embodiments, the geofence-based induction charging system 102 further includes a storage device 110 that comprises a distinct component from other components of the geofence-based induction charging system 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the geofence-based induction charging system 102. Storage device 110 may store information relied upon during operation of the geofence-based induction charging system 102, such as an EV database including a comprehensive list of vehicle models with corresponding parameters, geofence charging area data, and data (e.g., driver and/or account holder documents, such as payment accounts) to be utilized by the geofence-based induction charging system 102, and/or the like as described herein. In addition, storage device 110 may store control signals, device characteristics, and access credentials enabling interaction between the geofence-based induction charging system 102 and one or more of the EV devices 106A-106N or user devices 108A-108N.

The one or more EV devices 106A-106N and the one or more user devices 108A-108N may be embodied by any computing devices known in the art. The EV devices 106A-106N may refer to devices integrated with the EV during EV manufacture or after-market devices attached to the EV. The user device 108A-108N may refer to portable or handheld devices owned by EV drivers or passengers. The EV devices 106A-106N and the user devices 108A-108N may manage various functions of the EV, such as controlling the motor, managing battery charging, and monitoring power consumption. The one or more EVs 106A-106N and the one or more user devices 108A-108N need not themselves be independent devices but may be peripheral devices communicatively coupled to other computing devices.

### Example Implementing Apparatuses

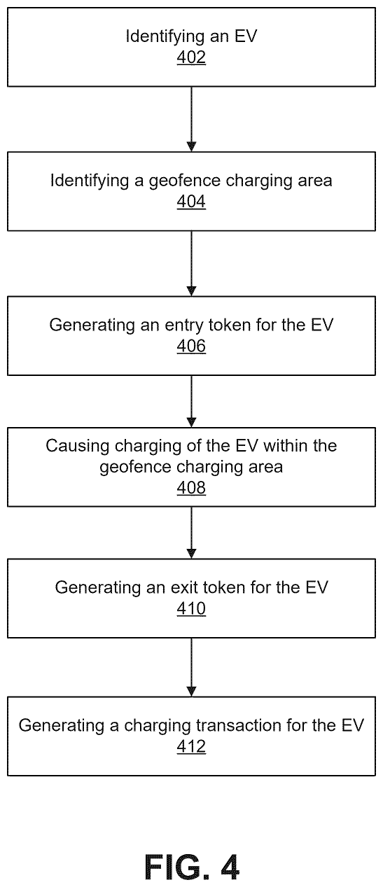

The geofence-based induction charging system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-8. As illustrated in FIG. 2, the apparatus 200 may include processor 202, memory 204, communications hardware 206, vehicle identification circuitry 208, token generation circuitry 210, payment transaction circuitry 212, geofence circuitry 214, and motion detection circuitry 216, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touchscreen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a vehicle identification circuitry 208 that identifies an EV entering a geofence charging area. The vehicle identification circuitry 208 may utilize processor 202, memory 204, or any other hardware component included in the apparatus 200 to perform these operations, as described in connection with FIGS. 4-8 below. The vehicle identification circuitry 208 may further utilize communications hardware 206 to gather data from a variety of sources (e.g., EV device 106A through EV device 106N or user device 108A through user device 108N or storage device 110, as shown in FIG. 1), and/or exchange data with a user, and in some embodiments may utilize processor 202 and/or memory 204 to identify an EV. The vehicle identification circuitry 208 may start to identify an EV when the EV is driving towards, at the entrance of, or right after entering the geofence charging area. The vehicle identification circuitry 208 may compare the vehicle parameters received from the EV through the communications hardware 206 with the stored vehicle parameters associated with the EV in the storage device 110. Further, the vehicle identification circuitry 208 may determine whether the vehicle parameters of the EV are valid, wherein the vehicle parameters comprise at least one or more of a vehicle identifier, a user account or billable account, a vehicle model, a battery type, a charging mode, a power consumption rate, or a self-charging rate. If the vehicle parameters are valid, the EV may be authorized to utilize the induction charging system. If the vehicle parameters are not valid, such as the battery is not compatible with the induction charging system or a billable account is not established, the EV may be notified to take a non-charging lane to exit the geofence charging area.

In addition, the apparatus 200 further comprises a token generation circuitry 210 that generates an entry token and exit token. The token generation circuitry 210 may utilize processor 202, memory 204, or any other hardware component included in the apparatus 200 to perform these operations, as described in connection with FIGS. 4-8 below. The token generation circuitry 210 may further utilize communications hardware 206 to gather data from a variety of sources (e.g., EV device 106A through EV device 106N or user device 108A through user device 108N or storage device 110, as shown in FIG. 1), and/or exchange data with a user, and in some embodiments may utilize processor 202 and/or memory 204 to generate the entry and exit token. The token generation circuitry 210 may generate the entry token when the EV enters the geofence charging area and the exit token when the EV exits the geofence charging area. The entry token comprises at least one or more of a vehicle identifier, an entry timestamp, an entry location, or an entry power level and the exit token comprises at least one or more of the vehicle identifier, an exit timestamp, an exit location, an updated power consumption rate, an updated self-charging rate, or an exit power level. The entry and exit timestamp mark the exact time when the EV enters and exits the geofence charging area. The entry and exit location may be GPS coordinates, start and end of a charging lane, a geofence charging area boundary, or etc. The updated power consumption rate and self-charging rate may be different from the power consumption rate and self-charging rate provided by the EV before the induction charging as a part of the vehicle parameters to reflect the actual rates adjusted based on the EV travel speed within the geofence charging area. After the token generation circuitry 210 generates the entry and exit token, a charging transaction may be further generated.

In addition, the apparatus 200 further comprises a payment transaction circuitry 212 that generates a charging transaction for the EV. The payment transaction circuitry 212 may utilize processor 202, memory 204, or any other hardware component included in the apparatus 200 to perform these operations, as described in connection with FIGS. 4-8 below. The payment transaction circuitry 212 may further utilize communications hardware 206 to gather data from a variety of sources (e.g., EV device 106A through EV device 106N or user device 108A through user device 108N or storage device 110, as shown in FIG. 1), and/or exchange data with a user, and in some embodiments may utilize processor 202 and/or memory 204 to generate a charging transaction. The payment transaction circuitry 212 may generate a charging transaction based on the entry and exit token generated by the token generation circuitry 210. The payment transaction circuitry 212 may provide a list of available payment options and communicate with the EV through the communications hardware 206. Further, the payment transaction circuitry 212 may initiate a payment of the charging transaction using the selected payment option by the EV and receive a payment confirmation from a financial institute whether the payment of the charging transaction is successful. If the payment of the charging transaction is successful, the payment transaction circuitry 212 may cause the communications hardware 206 to transmit a payment confirmation to the EV. If the payment of the charging transaction is not successful, the payment transaction circuitry 212 may cause the communications hardware 206 to transmit a payment failure to the EV. In some embodiments, the payment transaction circuitry may allow the EV to choose a different payment option and initiate another payment of charging transaction if the previous payment is not successful.

In addition, the apparatus 200 may further comprises a geofence circuitry 214 that identifies a geofence charging area. The geofence circuitry 214 may utilize processor 202, memory 204, or any other hardware component included in the apparatus 200 to perform these operations, as described in connection with FIGS. 4-8 below. The geofence circuitry 214 may further utilize communications hardware 206 to gather data from a variety of sources (e.g., EV device 106A through EV device 106N or user device 108A through user device 108N or storage device 110, as shown in FIG. 1), and/or exchange data with a user, and in some embodiments may utilize processor 202 and/or memory 204 to identify the geolocation charging area. The geofence circuitry 214 may utilize geolocation mapping services (e.g., Google Maps™, global position system (GPS), and/or the like) and/or vehicle geolocation location data comprising one or more of a location of an RFID scanner, a license plate camera, vehicle GPS data, a direction of travel, or a travel speed received from one or more EV devices 106A-106N and/or user devices 108A-108N to compare with a geofence charging area data in the storage device 110. The geofence circuitry 214 may further determine the geofence charging area based on a geofence charging area database. In some embodiments, the geofence circuitry 214 may determine one or more charging lanes/zones within the geofence charging area and remotely guide the EV to use the selected charging lane/zone with a respective charging speed, charging rate and charging sources through the communications hardware 206.

Further, the apparatus 200 may comprise a motion detection circuitry 216 that captures the entry/exit timestamps and entry/exit location data in response to the EV entering and exiting the geofence charging area. The motion detection circuitry 216 may utilize processor 202, memory 204, or any other hardware component included in the apparatus 200 to perform these operations, as described in connection with FIGS. 4-8 below. The motion detection circuitry 216 may further utilize communications hardware 206 to gather data from a variety of sources (e.g., EV device 106A through EV device 106N or user device 108A through user device 108N or storage device 110, as shown in FIG. 1), and/or exchange data with a user, and in some embodiments may utilize processor 202 and/or memory 204 to capture the entry/exit timestamps and entry/exit location data. In some embodiments, the motion detection circuitry 216 may track the EV travel speed and adjust the power consumption rate and self-charging rate automatically.

Although components 202-216 are described in part using functional language, it will be understood that the particular implementations necessarily include the use of particular hardware. It should also be understood that certain of these components 202-216 may include similar or common hardware. For example, the vehicle identification circuitry 208, the token generation circuitry 210, the payment transaction circuitry 212, the geofence circuitry 214, and the motion detection circuitry 216 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” with respect to elements of the apparatus therefore shall be interpreted as necessarily including the particular hardware configured to perform the functions associated with the particular element being described. Of course, while the terms “circuitry” should be understood broadly to include hardware, in some embodiments, the terms “circuitry” may in addition refer to software instructions that configure the hardware components of the apparatus 200 to perform the various functions described herein.

Although the vehicle identification circuitry 208, the token generation circuitry 210, the payment transaction circuitry 212, the geofence circuitry 214, and the motion detection circuitry 216 may leverage processor 202, memory 204, or communications hardware 206 as described above, it will be understood that any of the vehicle identification circuitry 208, the token generation circuitry 210, the payment transaction circuitry 212, the geofence circuitry 214, and the motion detection circuitry 216 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the vehicle identification circuitry 208, the token generation circuitry 210, the payment transaction circuitry 212, the geofence circuitry 214, and the motion detection circuitry 216 comprise particular machinery designed for performing the functions described herein in connection with such elements of apparatus 200.

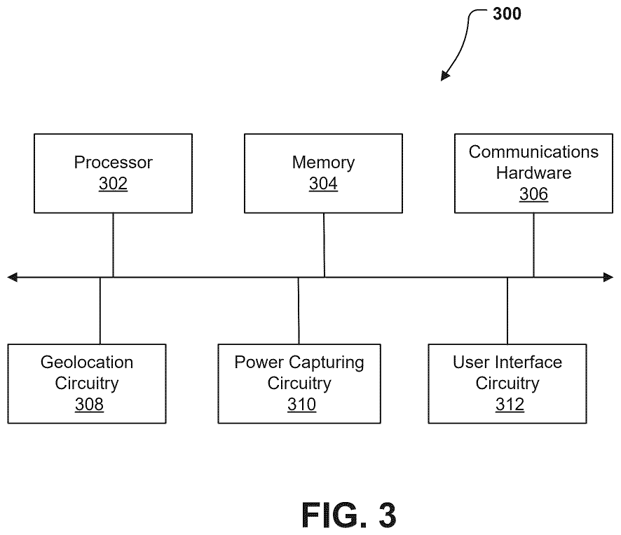

As illustrated in FIG. 3, an apparatus 300 is shown that represents an example EV device (e.g., any of EV device 110A-110N) or an example user device (e.g., any of user device 108A-108N). The apparatus 300 includes processor 302, memory 304, and communications hardware 306, each of which is configured to be similar to the similarly named components described above in connection with FIG. 2.

However, the apparatus 300 may also include geolocation circuitry 308, which includes hardware components designed for communicatively coupling with a satellite-based radio navigation system (e.g., global positioning system (GPS)) and/or a cellular network to determine the current location for the apparatus 300 (e.g., via GPS coordinates, radiolocation through triangulation between base station, or the like). The geolocation circuitry 308 may utilize processor 302, memory 304, or any other hardware component included in the apparatus 300 to perform these operations, as described in connection with FIGS. 4-8 below. The geolocation circuitry 308 may further utilize communications hardware 306 to communicate with navigation systems, cellular networks, and/or apparatus 200, or may otherwise utilize processor 302 and/or memory 304 to generate location data representative of the current location of the apparatus 300. In some embodiments, the geolocation circuitry 308 may identify a geofence charging area by comparing the GPS coordinates with the geofence data stored in a geofence charging area database.

In addition, the apparatus 300 may also include power capturing circuitry 310, which includes hardware components designed for capturing the entry power level and exit power level when the EV entering or exiting a geofence charging area. The power capturing circuitry 310 may utilize processor 302, memory 304, or any other hardware component included in the apparatus 300 to perform these operations, as described in connection with FIG. 4-8 below. The power capturing circuitry 310 may further utilize communications hardware 306 to transmit the captured entry and exit power level to the geofence-based induction charging system 102.

Further, the apparatus 300 may also include user interface circuitry 312, which includes hardware components designed for receiving user inputs and rendering virtual graphics outputs. The user interface circuitry 312 may utilize processor 302, memory 304, or any other hardware component included in the apparatus 300 to perform these operations, as described in connection with FIGS. 4-8 below. The user interface circuitry 312 may further utilize communications hardware 306 to transmit data representative of a user input and/or receive data to render as a virtual graphics output, or may otherwise utilize processor 302 and/or memory 304 to generate data representative of a user input and/or generate virtual graphics output, e.g., from based on received data. The user interface circuitry 312 may comprise one or more of a keyboard, pointing device, touchscreen, microphone with speech recognition interface, camera with gesture-based interface, or other input device capably of receiving various different user inputs. In addition, the user interface circuitry 312 may comprise a display device including one or more of a screen with graphical user interface (GUI), speaker, light emitting diode (LED), haptic technology device, or other output device capable of rendering information to a user.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200, or 300 may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Operations

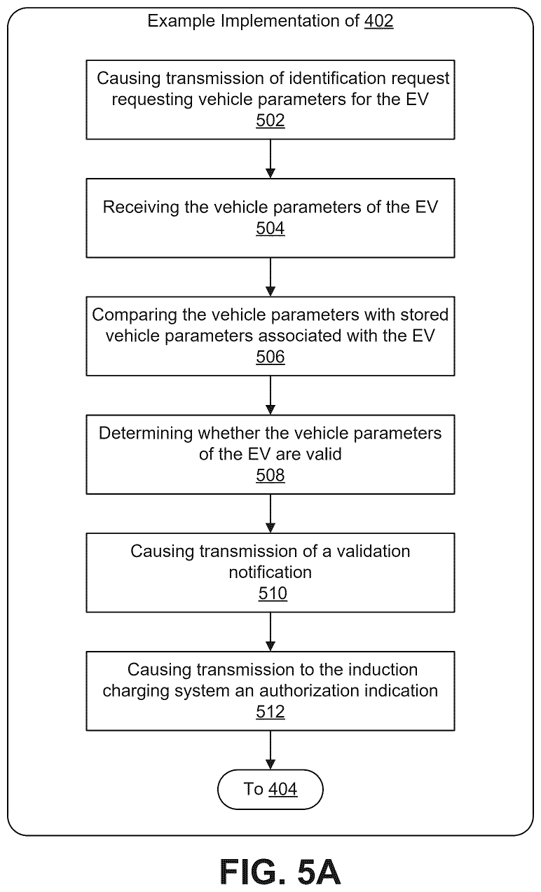

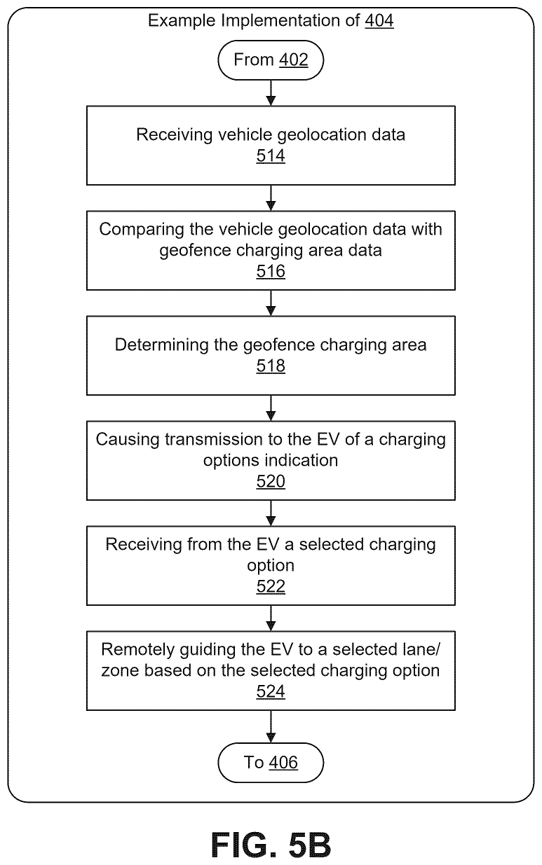

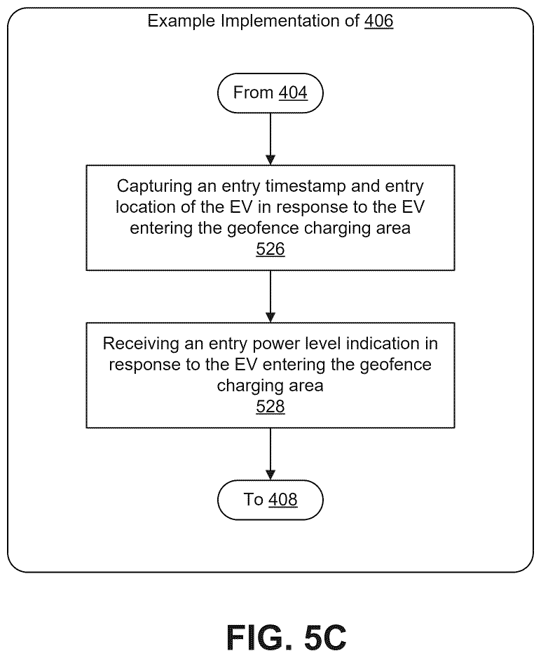

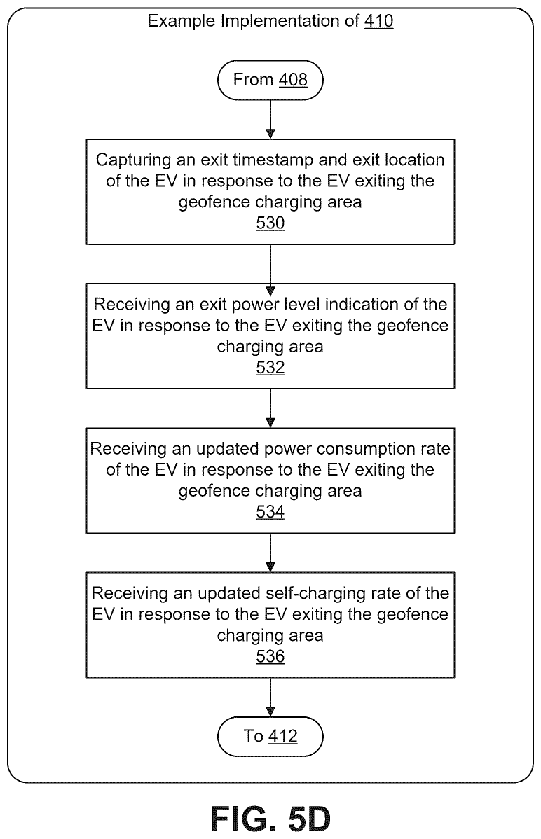

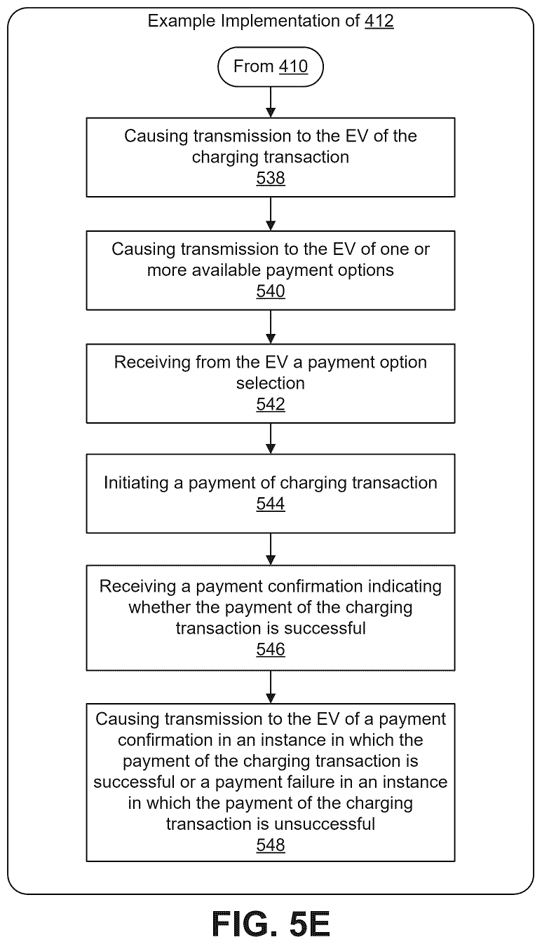

Turning to FIGS. 4, 5A-5E, 6, and 7A-7C, example flowcharts are illustrated that contain example operations implemented by example embodiments described herein. The operations illustrated in FIGS. 4 and 5A-5E may, for example, be performed by system device of the geofence-based induction charging system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, vehicle identification circuitry 208, token generation circuitry 210, payment transaction circuitry 212, geofence circuitry 214, motion detection circuitry 216, and/or any combination thereof. It will be understood that user interaction with the geofence-based induction charging system 102 may occur directly via communications hardware 206, or may instead be facilitated by a separate device (e.g., any of EV devices 106A-106N or user devices 108A-108N shown in FIG. 1, which may in turn be embodied by an apparatus 300, which is shown and described in connection with FIG. 3), as shown in FIG. 1, and which may have similar or equivalent physical componentry facilitating such user interaction.

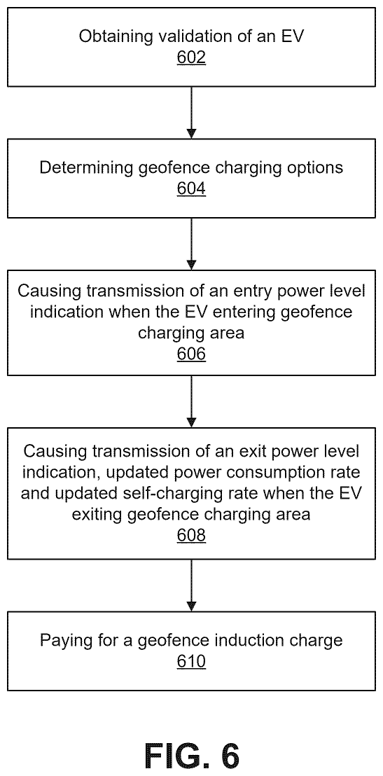

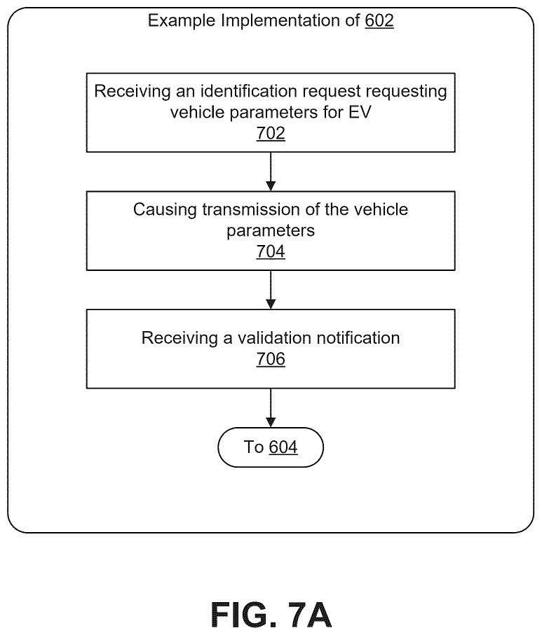

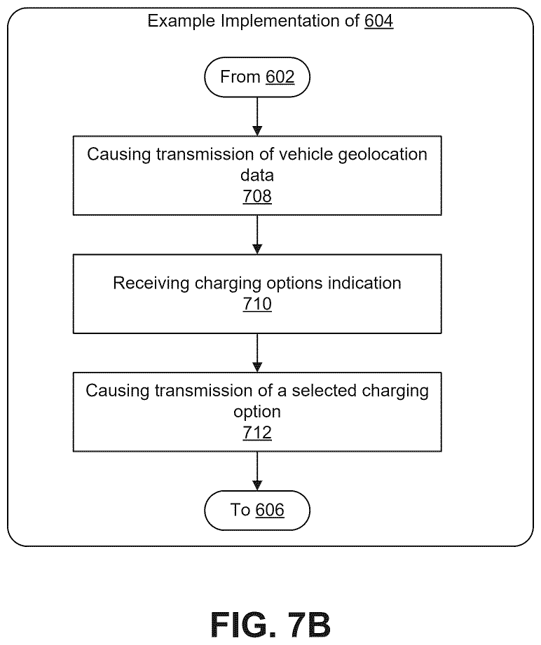

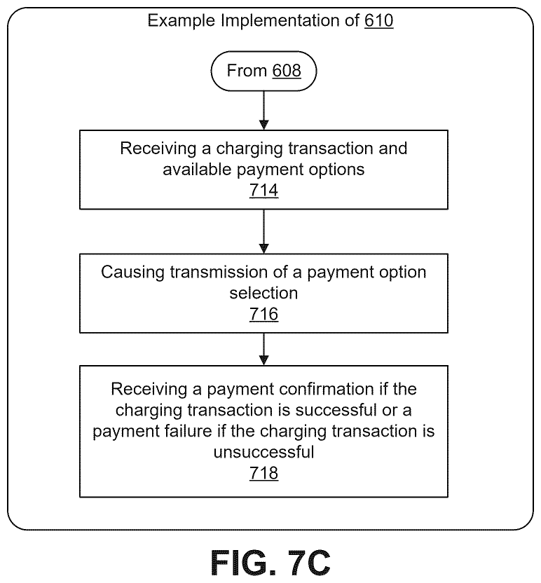

Meanwhile, the various operations described in connection with FIGS. 6 and 7A-7C may be performed by apparatus 300, which may utilize one or more of processor 302, memory 304, communications hardware 306, geolocation circuitry 308, power capturing circuitry 310, user interface circuitry 312, and/or any combination thereof.

Although example flowcharts describe only one EV, it should be contemplated that each operation in example flowcharts may be performed by the geofence-based induction charging system 102 on more than one EVs simultaneously.

Turning first to FIG. 4, example operations are shown for geofence-based induction charging by the geofence-based induction charging system 102.

As shown by operation 402, the apparatus 200 may include means, such as processor 202, memory 204, communications hardware 206, vehicle identification circuitry 208, or the like, for identifying an EV. Identifying an EV may start when the EV is driving towards, at the entrance of, or right after entering the geofence charging area. Identifying an EV may involve validating the vehicle parameters received from the EV. For example, the vehicle identification circuitry 208 may leverage the communications hardware 206 to receive vehicle parameters (e.g., vehicle model, battery type, etc.) and then validate the vehicle parameters by comparing with the stored vehicle parameters associated with the EV. If the validation is successful, the EV may be authorized to use the geofence-based induction charging, otherwise, the EV may be blocked from using the geofence-based induction charging. The underlying mechanism for implementing operation 402 will be described in greater detail below in connection with FIG. 5A.

As shown by operation 404, the apparatus 200 may include means, such as processor 202, memory 204, communications hardware 206, geofence circuitry 214, or the like, for identifying a geofence charging area. Identifying a geofence charging area may include determining the geolocation of the geofence charging area and the location of the EV relative to the geofence charging area, thus, the geofence-based induction charging system 102 may remotely guide the EV to travel through the geofence charging area properly. For example, the geofence circuitry 214 may leverage the communications hardware 206 to transmit guidance data (e.g., GPS coordinates, etc.) to the EV and an auto-pilot program of the EV may take control of the EV (e.g., with a drivers acknowledgement provided via a user interface) in order to guide the EV into the appropriate lane (e.g., fast charging lane, economy charging lane, etc.) based on the guidance data. In some embodiments, the geofence charging area may be divided into multiple lanes/zones with respective charging speed, charging rate and charging sources, and may also include one or more non-charging lanes, by identifying the geofence charging area with a high accuracy (e.g., at lane/zone level), the EV may be remotely guided to use a selected charging lane/zone, or one of the one or more non-charging lanes to exit the geofence charging area in case the EV is unauthorized (e.g., invalid vehicle parameters) for using the induction charging. The underlying mechanism for implementing operation 404 will be described in greater detail below in connection with FIG. 5B.

As shown by operation 406, the apparatus 200 may include means, such as processor 202, memory 204, communications hardware 206, token generation circuitry 210 motion detection circuitry 216, or the like, for generating an entry token. The entry token comprises at least one or more of a vehicle identifier, an entry timestamp, an entry location, or an entry power level and may be generated when an EV enters the geofence charging area. The entry token may be further used to generate a charging transaction for the EV. For example, the token generation circuitry 210 may leverage the communications hardware 206 to receive an entry power level from the EV, and further leverage the motion detection circuitry 216 to obtain an entry timestamp and an entry location when the EV enters the geofence charging area. In some embodiments, the EV may generate the entry token and transmit the entry token to the geofence-based induction charging system 102. The underlying mechanism for implementing operation 406 will be described in greater detail below in connection with FIG. 5C.

As shown by operation 408, the apparatus 200 may include means, such as processor 202, memory 204, communications hardware 206, or the like, for causing charging of an EV within the geofence charging area. For example, the communications hardware 206 may transmit a command (e.g., executable software instructions and/or the like as described herein) to enable one or more induction charging sources within the geofence charging area. In some embodiments, causing charging of an EV may further include notifying the EV to enable an EV charging switch or charging system.

As shown by operation 410, the apparatus 200 may include means, such as processor 202, memory 204, communications hardware 206, token generation circuitry 210, motion detection circuitry 216, or the like, for generating an exit token. The exit token comprises at least one or more of the vehicle identifier, an exit timestamp, an exit location, an updated power consumption rate, an updated self-charging rate, or an exit power level and may be generated when an EV exits the geofence charging area. The exit token may be further used to generate a charging transaction for the EV. For example, the token generation circuitry 210 may leverage the communications hardware 206 to receive an exit power level, an updated power consumption rate, and an updated self-charging rate from the EV, and further leverage the motion detection circuitry 216 to obtain an exit timestamp and an exit location when the EV exits the geofence charging area. In some embodiments, the EV may generate the exit token and transmit the exit token to the geofence-based induction charging system 102. The underlying mechanism for implementing operation 410 will be described in greater detail below in connection with FIG. 5D.

Finally, as shown by operation 412, the apparatus 200 may include means such as processor 202, memory 204, communications hardware 206, payment transaction circuitry 212, or the like, for generating a charging transaction for an EV. At the time instance when an EV exits the geofence charging area, a charging transaction may be automatically generated by the payment transaction circuitry 212, with an amount accurately reflect the received energy through the induction charging system. The charging transaction may then be processed in real-time (or near-real-time) with a payment option selected by the EV. In some embodiments, a payment confirmation or payment failure may be generated to notify the EV about the payment status. In some embodiments, if the payment is not successful, the EV may be allowed to change the payment option. The underlying mechanism for implementing operation 412 will be described in greater detail below in connection with FIG. 5E.

In some embodiments, operation 402 may be performed in accordance with the operations described by FIG. 5A. Turning now to FIG. 5A, example operations are shown for identifying an EV.

As shown by operation 502, the apparatus 200 may include means, such as processor 202, memory 204, communications hardware 206, geofence circuitry 214, or the like, for causing transmission of an identification request requesting vehicle parameters for an EV. For example, the communications hardware 206 may receive an indication that an EV is entering the geofence charging area through one or more RFID scanners or license plate cameras installed in the geofence charging area, or by leveraging the geofence circuitry 214 which may receive vehicle geolocation data, or directly from a GPS of the EV. Then, the communications hardware 206 may cause transmission of an identification request to the EV to request vehicle parameters for starting a validation process. The vehicle parameters may comprise at least one or more of a vehicle identifier, a user account or billable account, a vehicle model, a battery type, a charging mode, a power consumption rate, or a self-charging rate. In some embodiments, the EV may determine the location through the geolocation circuitry 308 and cause transmission of the vehicle parameters automatically to the geofence-based induction charging system 102 when entering the geofence charging area.

As shown by operation 504, the apparatus 200 may include means, such as processor 202, memory 204, communications hardware 206, or the like, for receiving vehicle parameters of the EV. After receiving the vehicle parameters, the communications hardware 206 may further store the received vehicle parameters in the memory 204 so that other components (e.g., vehicle identification circuitry 208) of the geofence-based induction charging system 102 may access the received vehicle parameters later. In some embodiments, the communications hardware 206 may perform sanity check (e.g., using Cyclic Redundancy Check (CRC) algorithm) to ensure no errors occurred during the transmission and may cause the EV to retransmit vehicle parameters if errors are identified.

As shown by operation 506, the apparatus 200 may include means, such as processor 202, memory 204, communications hardware 206, vehicle identification circuitry 208, or the like, for comparing received vehicle parameters in the memory 204 with stored vehicle parameters in the storage device 110 or another location in the memory 204. For example, based on the vehicle identifier and/or vehicle model, the vehicle identification circuitry 208 may first locate the saved vehicle parameters for the same EV or the same type of EV in the storage device 110 or in the memory 204. Further, the vehicle identification circuitry 208 may compare the received vehicle parameters with the saved vehicle parameters one by one to determine whether the vehicle parameters are valid.

As shown by operation 508, the apparatus 200 may include means, such as processor 202, memory 204, communications hardware 206, vehicle identification circuitry 208, or the like, for determining whether the vehicle parameters are valid. For example, the vehicle identification circuitry 208 may perform the validation by checking whether the vehicle model is compatible with the induction charging, the user account/billable account is valid, the charging mode is supported in the current geofence charging area, the power consumption rate and self-charging rate match the vehicle model and battery type, or etc. If a discrepancy is identified, the vehicle identification circuitry 208 may apply a certain criterion (e.g., a threshold, a decision logic, or an algorithm) to make a determination. In some embodiments, the validation is successful when all the vehicle parameters are valid. In some embodiments, the validation is successful if a set of critical vehicle parameters (e.g., the user account/billable account, the vehicle model, and the charging mode) are valid.

As shown by operation 510, the apparatus 200 may include means, such as processor 202, memory 204, communications hardware 206, or the like, for causing transmission of a validation notification notifying the EV whether the vehicle parameters are valid. The notification, transmitted to the EV by the communications hardware 206, may be a text message or an email to a phone number or an email address associated with the user account/billable account, in any other formats such as a voice prompt/a flashing light indication/an image display on one of the EV devices 106A-106N or user devices 108A-108N associated the EV.

Finally, as shown by operation 512, the apparatus 200 may include means, such as processor 202, memory 204, communications hardware 206, or the like, for causing transmission an authorization indication to the geofence-based induction charging system 102 indicating whether to allow or block the induction charging process based on whether the vehicle parameters are valid. In some embodiments, the communications hardware 206 may also transmit the indication whether to allow or block the induction charging to the EV.

In some embodiments, operation 404 may be performed in accordance with the operations described by FIG. 5B. Turning now to FIG. 5B, example operations are shown for identifying a geofence charging area.

As shown by operation 514, the apparatus 200 may include means, such as processor 202, memory 204, communications hardware 206, or the like, for receiving vehicle geolocation data. The vehicle geolocation data may include one or more of a location of an RFID scanner, a license plate camera, vehicle GPS data, a direction of travel, or a travel speed. In some embodiments, the vehicle geolocation data may be received from the EV directly. In some embodiments, the vehicle geolocation data may be received from different sources, such as one or more RFID scanners and license plate cameras installed within the geofence charging area, and the EV. After receiving the vehicle geolocation data, the communications hardware 206 may further store the data in the memory 204 so that other components (e.g., geofence circuitry 214) of the geofence-based induction charging system 102 may access the vehicle geolocation data later. In some embodiments, the communications hardware 206 may perform a sanity check (e.g., using Cyclic Redundancy Check (CRC) algorithm) to ensure no errors occurred during the transmission and may cause the EV and other devices (e.g., one or more RFID scanners and/or license plate cameras) to retransmit the vehicle parameters if errors are identified.

As shown by operation 516, the apparatus 200 may include means, such as processor 202, memory 204, communications hardware 206, geofence circuitry 214, or the like, for comparing the vehicle geolocation data with the geofence charging area data. The geofence charging area data may be stored in the storage device 110 or the memory 204. For example, the geofence circuitry 214 may perform the comparison by accessing the received vehicle geolocation data stored in the memory 204 and locating the geofence charging area data in the storage device 110 or another location in the memory 204. In some embodiments, the geofence circuitry 214 may pre-process the received vehicle geolocation data before comparing with the geofence charging area data using a digital processing (DSP) algorithm.

As shown by operation 518, the apparatus 200 may include means, such as processor 202, memory 204, communications hardware 206, geofence circuitry 214, or the like, for determining the geofence charging area based on a geofence charging area database. After comparing the received vehicle geolocation data with the geofence charging area data, the geofence circuitry 214 may derive the geolocation data of the geofence charging area and the location of the EV relative to the geolocation charging area. The geofence circuitry 214 may further verify or improve the accuracy of the geolocation data of the geofence charging area and the location of the EV relative to the geolocation charging area by accessing a geofence charging area database. In some embodiments, the geofence charging area may include multiple charging lanes with respective charging speed and charging rate and one or more non-charging lanes. In some embodiments, the geofence charging area may include one or more zones for stationary charging. In some embodiments, the geofence charging area may be divided into multiple zones with different charging sources, for example, one or more charging zones may support only one charging source and the other charging zones may support multiple charging sources. The geofence circuitry 214 may determine the geofence area with a high accuracy at lane/zone level, thus, the geofence-based induction charging system 102 may remotely guide the EV to use the proper lane/zone within the geofence charging area through the communications hardware 206.

As shown by operation 520, the apparatus 200 may include means, such as processor 202, memory 204, communications hardware 206, or the like, for causing transmission to the EV a charging options indication. The charging options may include a selection of charging modes (e.g., charging in a stationary position or in motion), and charging lane/zone with respective charging speed, charging cost and charging sources. The communications hardware 206 may transmit the indication to the EV as a text message, a voice prompt, or through a geofence induction charging system application which may be installed in the one of the EV devices 106A-106N or user devices 108A-108N associated with the EV.

As shown by operation 522, the apparatus 200 may include means, such as processor 202, memory 204, communications hardware 206, or the like, for receiving the selected charging option from the EV. In some embodiments, after receiving the selected charging option, the communications hardware 206 may check the selected option and request the EV to retransmit the selected option if transmission errors are identified.

Finally, as shown by operation 524, the apparatus 200 may include means, such as processor 202, memory 204, communications hardware 206, geofence circuitry 214, or the like, for remotely guiding the EV to the proper charging lane/zone based on the selected option. For example, the geofence circuitry 214 may leverage the communications hardware 206 to transmit guidance data (e.g., GPS coordinates, etc.) to the EV and an auto-pilot program of the EV may take control of the EV (e.g., with a drivers acknowledgement provided via a user interface) in order to guide the EV into the appropriate lane (e.g., fast charging lane, economy charging lane, etc.) based on the guidance data. In some embodiments, if the EV is unauthorized to use the induction charging (e.g., invalid vehicle parameters), the communications hardware 206 may remotely guide the EV to exit the geofence charging area by taking one of the non-charging lanes.

In some embodiments, operation 406 may be performed in accordance with the operations described by FIG. 5C. Turning now to FIG. 5C, example operations are shown for generating an entry token.

As shown by operation 526, the apparatus 200 may include means, such as processor 202, memory 204, communications hardware 206, geofence circuitry 214, motion detection circuitry 216, or the like, for capturing an entry timestamp, an entry location in response to an EV entering the geofence charging area. For example, the motion detection circuitry 216 may monitor the EV by leveraging the geofence circuitry 214 to capture the entry timestamp and the entry location of the EV. The entry timestamp marks the exact time the EV enters the geofence charging area. The entry location of the EV may be GPS coordinates, start and end of a charging lane, or a geofence charging area boundary. In some embodiments, the EV may automatically transmit the entry timestamp and the entry location using the geolocation circuitry 308 and the communications hardware 306 (shown in FIG. 3) to the geofence-based induction charging system 102 when the EV enters the geofence charging area.

Finally, as shown by operation 528, the apparatus 200 may include means, such as processor 202, memory 204, communications hardware 206, or the like, for receiving an entry power level indication in response to an EV entering the geofence charging area. The entry power level indication marks the power level of the EV before entering the geofence induction charging. The entry power level may be captured by the power capturing circuitry 310 (shown in FIG. 3) of the EV devices 106A-106N or user devices 108A-108N (shown in FIG. 1) through an onboard sensor. In some embodiments, the entry power level may be captured by the charging sources, such as the power transmitter embedded under the highway, or installed on the induction tower.

In some embodiments, operation 408 may be performed in accordance with the operations described by FIG. 5D. Turning now to FIG. 5D, example operations are shown for generating an exit token.

As shown by operation 530, the apparatus 200 may include means, such as processor 202, memory 204, communications hardware 206, geofence circuitry 214, motion detection circuitry 216, or the like, for capturing an exit timestamp, an exit location in response to an EV exiting the geofence charging area. For example, the motion detection circuitry 216 may monitor the EV by leveraging the geofence circuitry 214 to capture the exit timestamp and the exit location of an EV. The exit timestamp marks the exact time the EV exits the geofence charging area. The exit location the EV may be GPS coordinates, start and end of a charging lane, or a geofence charging area boundary. In some embodiments, the EV may automatically transmit the exit timestamp and the exit location using the geolocation circuitry 308 and the communications hardware 306 (shown in FIG. 3) to the geofence-based induction charging system 102 when the EV exits the geofence charging area.

As shown by operation 532, the apparatus 200 may include means, such as processor 202, memory 204, communications hardware 206, or the like, for receiving an exit power level indication in response to an EV exiting the geofence charging area. The exit power level indication marks the power level when the EV exits the geofence charging area. The exit power level may be captured by the power capturing circuitry 310 (shown in FIG. 3) of the EV devices 106A-106N or user devices 108A-108N (shown in FIG. 1) through an onboard sensor. In some embodiments, the exit power level may be captured by the charging sources, such as the power transmitter embedded under the highway, or installed on the induction tower.

As shown by operation 534, the apparatus 200 may include means, such as processor 202, memory 204, communications hardware 206, motion detection circuitry 216, or the like, for receiving an updated power consumption rate in response to an EV exiting the geofence charging area. The updated power consumption rate may reflect the adjusted power consumption rate based on the travel speed of the EV within the geofence area (e.g., an averaged power consumption), thus, may be more accurate than the power consumption rate provided before starting the induction charging as one of the vehicle parameters. In some embodiments, instead of receiving the updated power consumption rate, the geofence-based induction charging system 102 may leverage the motion detection circuitry 216 to update the power consumption rate automatically.

Finally, as shown by operation 536, the apparatus 200 may include means, such as processor 202, memory 204, communications hardware 206, motion detection circuitry 216, or the like, for receiving an updated self-charging rate in response to EV exiting the geofence charging area. The updated self-charging rate may reflect the adjusted self-charging rate based on the travel speed within the geofence area (e.g., an averaged self-charging rate), thus, may be more accurate than the self-charging rate provided before starting the induction charging. In some embodiments, instead of receiving the updated self-charging rate, the geofence-based induction charging system 102 may leverage the motion detection circuitry 216 to update the self-charging rate automatically.

In some embodiments, operation 412 may be performed in accordance with the operations described by FIG. 5E. Turning now to FIG. 5E, example operations are shown for causing a charging transaction.

As shown by operation 538, the apparatus 200 may include means, such as processor 202, memory 204, communications hardware 206, payment transaction circuitry 212, or the like, for generating a charging transaction. The amount of the charging transaction may be generated based on the following formula:

$$charging transaction = ( ( {P}_{x} - {P}_{e} ) + \overline{{R}_{c}} \times ( {T}_{x} - {T}_{e} ) - \overline{{R}_{s}} \times ( {T}_{x} - {T}_{e} ) ) * C ( m ) ; \qquad ( 1 )$$

where Pₓ and Pₑ stand for the exit and entry power level, respectively; R̅_̅{̅c̅}̅ and R̅ₛ̅ stand for updated power consumption rate and self-charging rate, respectively; Tₓ and Tₑ stand for the exit and entry timestamp, respectively; and C(m) stands for the unit charging cost for the geofence induction charge (e.g., per mAh), which may be a function of charging options m. Different from the traditional approaches which may only consider the difference between the exit power level and entry power level (Pₓ−Pₑ) and then multiply by a fixed unit charging cost, example embodiments described herein consider the power level change caused by power consumption and self-charging within the geofence charging area, thus, may accurately reflect the actual power received from the induction charging. Further, the power consumption rate R̅_̅{̅c̅}̅ and self-charging rate R̅ₛ̅ may be updated based on the EV travel speed and averaged over the time spent within the geofence charging area. In addition, the unit charging cost depends on the charging options, such as the charging modes, charging lane and the charging sources. Therefore, example embodiments generate the charging transaction with a high accuracy. In some embodiments, the power consumption rate R̅_̅{̅c̅}̅ and self-charging rate R̅ₛ̅ may be continuous functions with respect to time, then the amount of the charging transaction may be generated based on the following formula:

$$charging transaction = ( ( {P}_{x} - {P}_{e} ) + {\int }_{{T}_{e}}^{{T}_{x}} {R}_{c} ( t ) dt - {\int }_{{T}_{e}}^{{T}_{x}} {R}_{s} ( t ) dt ) * C ( m ) ; \qquad ( 2 )$$

where R_{c} (t) stands for the continuous power consumption function with respect to t, and Rₛ (t) stands for the continuous self-charging function with respect to t. In some embodiments, the user account/billable account may specify spending a fixed amount of charging cost within the geofence charging area. In such a case, the geofence-based induction charging system may request the EV to transmit power level, updated power consumption rate and self-charging rate constantly at a fixed time schedule (e.g., every 30 seconds) within the geofence charging area to determine when the charging cost has reached the fixed allowed amount so that the charging may be automatically disabled.

As shown by operation 540, the apparatus 200 may include means, such as processor 202, memory 204, communications hardware 206, or the like, for causing transmission of one or more available payment options. The one or more available payment options may be provided based on the user account/billable account which may be a personal account or corporate account (e.g., for a business trip, or a fleet EV). The one or more payment options may include credit card payment, debit card payment, electronic funds transfer (EFT), digital/mobile/online payment, or etc. In some embodiments, the one or more payment options may also include an option to splitting the charging transaction among EV driver and passengers. In some embodiments, the one or more payment options may also include using cryptocurrency or carbon credits. In some embodiments, the one or more payment options may also include a “bill now pay later” option.

As shown by operation 542, the apparatus 200 may include means, such as processor 202, memory 204, communications hardware 206, or the like, for receiving payment option selection of the EV. In some embodiments, if the communications hardware 206 identifies an error in the payment option selection, the communications hardware 206 may cause the EV to retransmit the payment option selection.

As shown by operation 544, the apparatus 200 may include means, such as processor 202, memory 204, communications hardware 206, payment transaction circuitry 212, or the like, for initiating a payment of the charging transaction. For example, when a valid payment option is received by the communications hardware 206, the payment transaction circuitry 212 may initiate a payment process with the corresponding financial institute based on the selected payment option.

As shown by operation 546, the apparatus 200 may include means, such as processor 202, memory 204, communications hardware 206, or the like, for receiving a payment confirmation indicating whether the payment of charging transactions is successful from the financial institute.

Finally, as shown by operation 548, the apparatus 200 may include means, such as processor 202, memory 204, communications hardware 206, or the like, for causing transmission to the EV of a payment confirmation in an instance in which the payment of the charging transaction is successful or a payment failure in an instance in which the payment of the charging transaction is unsuccessful. The notification, transmitted to the EV by the communications hardware 206, may be a text message or an email to a phone number or an email address associated with the user account/billable account, or in any other formats such as a voice prompt/a flashing light indication/an image display on one of the EV devices 106A-106N or user devices 108A-108N associated the EV.

Turning next to FIG. 6, example operations are shown for geofence-based induction charging by the EV devices 106A-106N or user devices 108A-108N.

As shown by operation 602, the apparatus 300 includes means, such as processor 302, memory 304, communications hardware 306, geolocation circuitry 308, or the like, for obtaining validation of an EV. For example, the EV may receive a request from the geofence-based induction charging system 102 for transmitting the vehicle parameters, when the EV is driving towards, at the entrance of, or right after entering the geofence charging area. In some embodiments, the EV may automatically send the vehicle parameters by leveraging the geolocation circuitry 308 and the communications hardware 306 when entering the geofence charging area. The underlying mechanism for implementing operation 602 will be described in greater detail below in connection with FIG. 7A.

As shown by operation 604, the apparatus 300 includes means, such as processor 302, memory 304, communications hardware 306, user interface circuitry 312, or the like, for determining charging options. The charging options may include a selection of charging modes (e.g., charging in stationary or in motion), and charging lane/zone with respective charging speed, charging cost and charging sources. For example, the communications hardware 306 may receive a set of available charging options. The user interface circuitry 312 may further display the available charging options on the touchscreen of the EV devices 106A-106N or user devices 108A-108N. The driver or the passengers may then determine a preferred charging option by touching the corresponding location on the screen. The underlying mechanism for implementing operation 602 will be described in greater detail below in connection with FIG. 7B.

As shown by operation 606, the apparatus 300 includes means, such as processor 302, memory 304, communications hardware 306, geolocation circuitry 308, power capturing circuitry 310, or the like, for causing transmission of an entry power level indication. The EV may receive a request from the geofence-based induction charging system 102 when entering the geofence charging area to transmit the entry power level, which may be captured by power capturing circuitry 310. In some embodiments, the EV may automatically send the entry power level by leveraging the geolocation circuitry 308 and the communications hardware 306 when entering the geofence charging area.

As shown by operation 608, the apparatus 300 includes means, such as processor 302, memory 304, communications hardware 306, geolocation circuitry 308, power capturing circuitry 310, or the like, for causing transmission of an exit power level indication, an updated power consumption rate and self-charging rate. The EV may receive a request from the geofence-based induction charging system 102 when exiting the geofence charging area to transmit the exit power level, the updated power consumption rate and self-charging rate. In some embodiments, the EV may automatically send the exit power level, the updated power consumption rate and self-charging rate by leveraging the geolocation circuitry 308 and the communications hardware 306 when exiting the geofence charging area.

The exit power level may be captured by the power capturing circuitry 310. The updated power consumption rate and the self-charging rate, as described in detail in connection with operation 532 and 534 in FIG. 5D, respectively, may be captured by the power capturing circuitry 310 by leveraging the geolocation circuitry 308, and then transmitted to the geofence-based induction charging system 102 by the communications hardware 306.

Finally, as shown by operation 610, the apparatus 300 includes means, such as processor 302, memory 304, communications hardware 306, user interface circuitry 312, or the like, for paying for the geofence induction charging. The EV may be provided an opportunity to select a payment option among one or more available payment options. For example, the communications hardware 306 may receive a set of available payment options. The user interface circuitry 312 may further display the available charging options on the touchscreen of the EV devices 106A-106N or user devices 108A-108N. The driver or the passengers may then determine a preferred payment option by touching the corresponding location on the screen. In some embodiments, the EV may be provided another opportunity to select a different payment option in case the previous payment of the charging transaction is not successful. The underlying mechanism for implementing operation 602 will be described in greater detail below in connection with FIG. 7C.

In some embodiments, operation 602 may be performed in accordance with the operations described by FIG. 7A. Turning now to FIG. 7A, example operations are shown for obtaining validation of an EV.

As shown by operation 702, the apparatus 300 may include means, such as processor 302, memory 304, communications hardware 306, or the like, for receiving an identification request requesting vehicle parameters from the geofence-based induction charging system 102. In some embodiments, receiving an identification request may not be needed for transmitting the vehicle parameters because the EV may automatically identify entering a geofence charging area by leveraging the geolocation circuitry 308.

As shown by operation 704, the apparatus 300 may include means, such as processor 302, memory 304, communications hardware 306, or the like, for causing transmission of vehicle parameters to the geofence-based induction charging system 102. In some embodiments, the communications hardware 306 may retransmit the vehicle parameters if the geofence-based induction charging system 102 identifies errors during the transmission.

Finally, as shown by operation 706, the apparatus 300 may include means, such as processor 302, memory 304, communications hardware 306, or the like, for receiving a validation notification indicating whether the vehicle parameters are valid and whether an induction charging process is ready to start. In some embodiments, when the vehicle parameters are valid, the EV may enable a charging switch or a charging system on vehicle if originally disabled to prepare for induction charging. In some embodiments, when the vehicle parameters are invalid, the EV may disable a charging switch or a charging system on vehicle if already enabled.

In some embodiments, operation 604 may be performed in accordance with the operations described by FIG. 7B. Turning now to FIG. 7B, example operations are shown for determining charging options.

As shown by operation 708, the apparatus 300 may include means, such as processor 302, memory 304, communications hardware 306, geolocation circuitry 308, or the like, for causing transmission of vehicle geolocation data. The vehicle geolocation data may be captured by the geolocation circuitry 308 and transmitted by the communications hardware 306 when receiving a request from the geofence-based induction charging system 102. In some embodiments, the vehicle geolocation data may be captured by the geolocation circuitry 308 and transmitted by the communications hardware 306 constantly to the geofence-based induction charging system 102 at a fixed time schedule (e.g., every 30 seconds).

As shown by operation 710, the apparatus 300 may include means, such as processor 302, memory 304, communications hardware 306, user interface circuitry 312, or the like, for receiving an indication of charging options. The charging options may include a selection of charging modes (e.g., charging in stationary or in motion), and charging lanes/zones with a respective charging speed, charging rate and charging sources. For example, the communications hardware 306 may receive a set of available charging options. The user interface circuitry 312 may further display the available charging options on the touchscreen of the EV devices 106A-106N or user devices 108A-108N. The driver or the passengers may then determine a preferred charging option by touching the corresponding location on the screen. The available charging options may be displayed on the user interface circuitry 312 through a text, image or voice prompt. In some embodiments, the available charging options may be displayed on the user interface circuitry 312 through a geofence-based induction charging system application. Based on the available charging options, the EV driver and/or passengers may decide a charging option. In some embodiments, default charging option may be utilized for induction charging if no charging option is selected within a pre-defined amount of time (e.g., 20 seconds).

Finally, as shown by operation 712, the apparatus 300 may include means, such as processor 302, memory 304, communications hardware 306, or the like, for causing transmission of the selected charging option to the geofence-based induction charging system 102. In some embodiments, the EV may retransmit the selected charging option based on an indication received from the geofence-based induction charging system 102 indicating invalid charging option selected or errors occurred during transmission.

In some embodiments, operation 610 may be performed in accordance with the operations described by FIG. 7C. Turning now to FIG. 7C, example operations are shown for paying for geofence-based induction charging.

As shown by operation 714, the apparatus 300 may include means, such as processor 302, memory 304, communications hardware 306, user interface circuitry 312, or the like, for receiving one or more payment options for the charging transaction. For example, the communications hardware 306 may receive a set of available payment options. The user interface circuitry 312 may further display the available charging options on the touchscreen of the EV devices 106A-106N or user devices 108A-108N. The driver or the passengers may then determine a preferred payment option by touching the corresponding location on the screen. The available charging options may be displayed on the user interface circuitry 312 through a text, image or voice prompt. In some embodiments, the available payment options may be displayed on the user interface circuitry 312 through a geofence-based induction charging system application. Based on the available payment options, the EV driver and/or passengers may decide a payment option. In some embodiments, the payment may be split among the driver and passengers. In some embodiments, default payment option may be utilized for induction charging if no payment selection is made within a pre-defined amount of time (e.g., 5 minutes).

As shown by operation 716, the apparatus 300 may include means, such as processor 302, memory 304, communications hardware 306, or the like, for causing transmission of a payment option selection to the geofence-based induction charging system 102. In some embodiments, the EV may retransmit the selected payment option based on an indication received from the geofence-based induction charging system 102 indicating invalid charging option or errors occurred during transmission.

Finally, as shown by operation 718, the apparatus 300 may include means, such as processor 302, memory 304, communications hardware 306, user interface circuitry 312, or the like, for receiving a payment confirmation in an instance in which the payment of the charging transaction is successful or a payment failure in an instance in which the payment of the charging transaction is unsuccessful. The notification may be further displayed on the screen of the EV devices 106A-106N or user devices 108A-108N. In some embodiments, the EV driver or passengers may select another payment option if the previous payment is not successful.

FIGS. 4, 5A-5E, 6, and 7A-7C illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

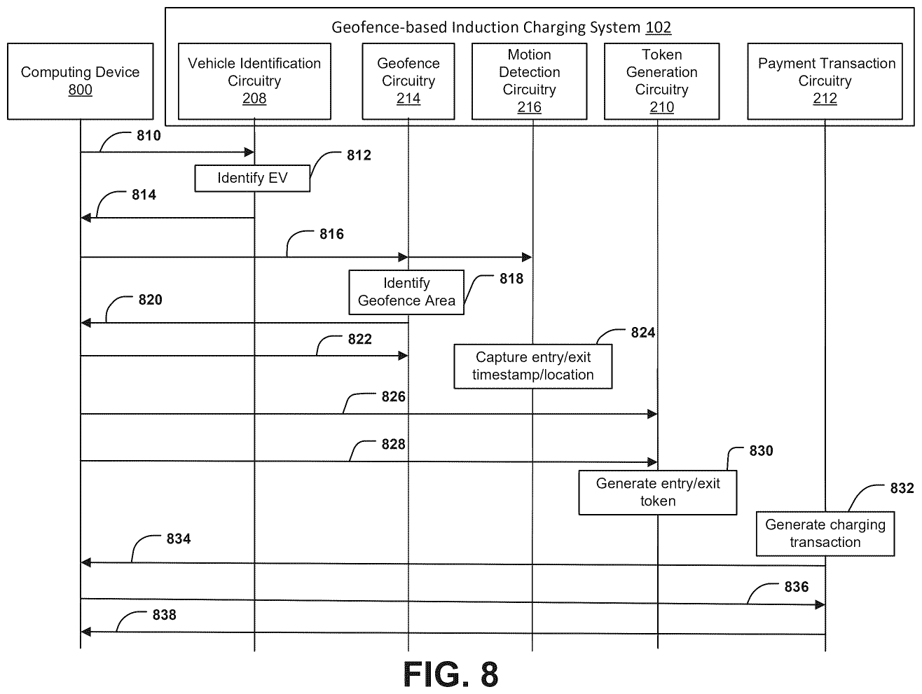

FIG. 8 shows a swim lane diagram illustrating example operations (e.g., as described above in connection with FIGS. 4, 5A-5E, 6, and 7A-7C) performed by components of the environment depicted in FIG. 1 to produce various benefits of the implementations described herein. The operations shown in the swim lane diagram performed by the Computing Device 800 (e.g., any of EV devices 106A-106N and/or user devices 108A-108N as described above) are shown along the line extending from the box labeled “Computing Device 800,” operations performed by the vehicle identification circuitry 208 of the geofence-based induction charging system 102 are shown along the line extending from the box labeled “Vehicle Identification Circuitry 208,” operations performed by the geofence circuitry 214 of the geofence-based induction charging system 102 are shown along the line extending from the box labeled “Geofence Circuitry 214,” operations performed by the motion detection circuitry 216 of the geofence-based induction charging system 102 are shown along the line extending from the box labeled “Motion Detection Circuitry 216,” operations performed by the token generation circuitry 210 of the geofence-based induction charging system 102 are shown along the line extending from the box labeled “Token Generation Circuitry 210,” and operations performed by the payment transaction circuitry 212 of the geofence-based induction charging system 102 are shown along the line extending from the box labeled “Payment Transaction Circuitry 212.” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIG. 8.

At operation 810, when an EV is driving towards, at the entrance of or right after entering the geofence charging area, the EV transmits vehicle parameters (either automatically or based on a request from the geofence-based induction charging system 102) to the geofence-based induction charging system 102. After receiving the vehicle parameters, the vehicle identification circuitry 208 identifies the EV at operation 812 by validating the vehicle parameters. The validation may be performed by comparing the received vehicle parameters with the stored vehicle parameters of the same EV or the same type of EV in the storage device 110. After validation, a validation notification is transmitted to the EV at operation 814. In this example, the vehicle parameters are successfully validated.

At operation 816, the EV transmits vehicle geolocation data to the geofence circuitry 214 and the motion detection circuitry 216 (either automatically based on a fixed time schedule or based on a request from the geofence-based induction charging system 102). The vehicle geolocation data may be the GPS data of the EV, or the like. At operation 818, the geofence circuitry 214 identifies the geofence charging area by comparing the received vehicle geolocation data with the geofence charging area data based on a geofence charging area database. The geofence circuitry 214 may further determine the location of the EV relative to the geofence charging area. A charging options indication is transmitted to the EV at operation 820. The EV makes a selection and transmits the selected charging option to the geofence circuitry 214 at operation 822. Based on the selected charging option, the EV is remotely guided to the proper charging lane/zone in the geofence charging area.

At operation 824, the motion detection circuitry 216 captures the entry and exit timestamp and location of the EV in response to the EV entering and exiting the geofence charging area by leveraging the geofence circuitry 214. At operation 826 the EV transmits the entry power level in response to the EV entering the geofence charging area, and at operation 828 the EV transmits the exit power level, updated power consumption and self-charging rate in response to the EV exiting the geofence charging area to the token generation circuitry 210. At operation 830, the token generation circuitry 210 generates an entry token and an exit token, based on the entry and exit timestamp and location, entry and exit power level, and updated power consumption and self-charging rate.

At operation 832, the payment transaction circuitry 212 generates a charging transaction based on the entry token and the exit token. The payment transaction circuitry 212 transmits the charging transaction and one or more payment options to the EV at operation 834. The EV makes a selection and transmits the selected payment option to the payment transaction circuitry 212 at operation 836. After the charging transaction is successfully processed in this example, the payment transaction circuitry 212 transmits a payment confirmation to the EV at operation 838.

In some embodiments, some of the operations described above in connection with FIGS. 4-8 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses of a geofence-based induction charging system. By generating charging transactions customized for each individual EV based on different vehicle parameters and charging characteristics and taking consideration of EV power consumption and self-charging within the geofence charging area, example embodiments generate charging transactions with a high accuracy. Moreover, by generating charging transactions at the time instance when an EV exits the geofence charging area based on an entry token and exit token, example embodiments process charge transactions efficiently and may capture any payment issues at the earliest time. Finally, by supporting different charging options such as charging modes, charging sources, and charging lanes/zones, example embodiments provide flexibility to accommodate different charging capabilities and charging demands of EVs.

As these examples all illustrate, example embodiments contemplated herein provide technical solutions for a revolutionary EV charging infrastructure which solves real-world problems of providing convenience, safety, energy efficiency, and environmental conservation faced during the widespread adoption of EVs in the near future. By empowering wireless and contactless EV charging either while stationary or while in motion, and at the same time offering flexible, accurate and efficient payment processing for EV charging, example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for geofence-based electrical vehicle (EV) induction charging, the method comprising:
identifying, by vehicle identification circuitry, an EV;
identifying, based on geofence circuitry, a geofence charging area;
generating, by token generation circuitry, an entry token for the EV;
causing charging, by an induction charging system, of the EV within the geofence charging area;
generating, by the token generation circuitry, an exit token for the EV; and
generating, by payment transaction circuitry, a charging transaction for the EV.

2. The method of claim 1, wherein identifying the EV further comprises:
causing transmission, by communications hardware to the EV, of an identification request requesting vehicle parameters for the EV, wherein the vehicle parameters comprise at least one or more of a vehicle identifier, a user account or billable account, a vehicle model, a battery type, a charging mode, a power consumption rate, or a self-charging rate, wherein one or more of the power consumption rate or the self-charging rate are variable based on a travel speed of the EV;
receiving, by the communications hardware from the EV, the vehicle parameters of the EV;
comparing, by the vehicle identification circuitry, the vehicle parameters with stored vehicle parameters associated with the EV;
determining, by the vehicle identification circuitry, whether the vehicle parameters of the EV are valid;
causing transmission, by the communications hardware to the EV, of a validation notification indicating whether the vehicle parameters are valid and whether an induction charging process is ready to start; and
causing transmission, by the communications hardware to the induction charging system and based on whether the vehicle parameters are valid, an authorization indication indicating whether to allow or block the induction charging process.

3. The method of claim 1, wherein identifying the geofence charging area further comprises:
receiving, by communications hardware, vehicle geolocation data comprising one or more of a location of an RFID scanner, a license plate camera, vehicle GPS data, a direction of travel, or a travel speed;
comparing, by the geofence circuitry, the vehicle geolocation data with geofence charging area data; and
determining, by the geofence circuitry and based on a geofence charging area database, the geofence charging area.

4. The method of claim 3, wherein identifying the geofence charging area further comprises:
causing transmission, by the communications hardware to the EV, of a charging options indication indicating a plurality of lanes/zones, wherein each of the plurality of lanes/zones is associated with a respective charging speed, a respective charging rate, or one or more respective charge sources;
receiving from the EV, by the communications hardware, a selected charging option; and
remotely guiding the EV, by the communications hardware, to a selected lane/zone based on the selected charging option.

5. The method of claim 1, wherein the entry token comprises at least one or more of a vehicle identifier, an entry timestamp, an entry location, or an entry power level, wherein the exit token comprises at least one or more of the vehicle identifier, an exit timestamp, an exit location, an updated self-charging rate, an updated power consumption rate, or an exit power level.

6. The method of claim 1, wherein generating the entry token further comprises:
capturing, by motion detection circuitry, an entry timestamp and entry location of the EV in response to the EV entering the geofence charging area; and
receiving, by communications hardware, an entry power level indication of the EV in response to the EV entering the geofence charging area.

7. The method of claim 1, wherein generating the exit token further comprises:
capturing, by motion detection circuitry, an exit timestamp and exit location of the EV in response to the EV exiting the geofence charging area;
receiving, by communications hardware, an exit power level indication of the EV in response to the EV exiting the geofence charging area;
receiving, by the communications hardware, an updated power consumption rate of the EV in response to the EV exiting the geofence charging area; and
receiving, by the communications hardware, an updated self-charging rate of the EV in response to the EV exiting the geofence charging area.

8. The method of claim 1, wherein generating the charging transaction further comprises:
causing transmission, by communications hardware to the EV, of the charging transaction, wherein the charging transaction is based on the entry token and the exit token;
causing transmission, by the communications hardware to the EV, of one or more available payment options; and
receiving, by the communications hardware from the EV, a payment option selection indicating at least one of the one or more available payment options.

9. The method of claim 8, wherein generating the charging transaction further comprises:
initiating, by the payment transaction circuitry and based on the payment option selection, a payment of the charging transaction;
receiving, by the payment transaction circuitry, a payment confirmation indicating whether the payment of the charging transaction is successful; and
causing transmission, by the communications hardware to the EV, of the payment confirmation in an instance in which the payment of the charging transaction is successful or a payment failure in an instance in which the payment of the charging transaction is unsuccessful.

10. An apparatus of geofence based electrical vehicle (EV) induction charging, the apparatus comprising:
vehicle identification circuitry configured to identify an EV;
geofence circuitry configured to identify a geofence charging area;
token generation circuitry configured to generate an entry token for the EV;
an induction charging system configured to cause charging of the EV within the geofence charging area;
wherein the token generation circuitry is further configured to generate an exit token for the EV; and
payment transaction circuitry configured to generate a charging transaction for the EV.

11. The apparatus of claim 10, further comprising:
communications hardware configured to:
cause transmission to the EV, of an identification request requesting vehicle parameters for the EV, wherein the vehicle parameters comprise at least one or more of a vehicle identifier, a user account or billable account, a vehicle model, a battery type, a charging mode, a power consumption rate, or a self-charging rate, wherein one or more of the power consumption rate or the self-charging rate are variable based on a travel speed of the EV, and
receive the vehicle parameters of the EV,
wherein the vehicle identification circuitry is further configured to:
compare the vehicle parameters with stored vehicle parameters associated with the EV, and
determine whether the vehicle parameters of the EV are valid,
wherein the communications hardware is further configured to:
cause transmission to the EV of a validation notification indicating whether the vehicle parameters are valid and whether an induction charging process is ready to start, and
cause transmission to the induction charging system and based on whether the vehicle parameters are valid, an authorization indication indicating whether to allow or block the induction charging process.

12. The apparatus of claim 10, further comprising:
communications hardware configured to receive vehicle geolocation data comprising one or more of a location of an RFID scanner, a license plate camera, vehicle GPS data, a direction of travel, or a travel speed,
wherein the geofence circuitry is further configured to:
compare the vehicle geolocation data with geofence charging area data, and
determine, based on a geofence charging area database, the geofence charging area.

13. The apparatus of claim 12, wherein the communications hardware is further configured to:
cause transmission to the EV of a charging options indication indicating a plurality of lanes/zones, wherein each of the plurality of lanes/zones is associated with a respective charging speed, a respective charging rate, or one or more charging sources,
receive from the EV a selected charging option, and
remotely guide the EV to a selected lane/zone based on the selected charging option.

14. The apparatus of claim 10, wherein the entry token comprises at least one or more of a vehicle identifier, an entry timestamp, an entry location, or an entry power level; and wherein the exit token comprises at least one or more of the vehicle identifier, an exit time, an exit location, a self-charging rate, a power consumption rate, or an exit power level.

15. The apparatus of claim 10, further comprising:
motion detection circuitry configured to capture an entry timestamp and entry location of the EV in response to the EV entering the geofence charging area; and
communications hardware configured to receive an entry power level indication in response to the EV entering the geofence charging area.

16. The apparatus of claim 10, further comprising:
motion detection circuitry configured to capture an exit timestamp and exit location of the EV in response to the EV exiting the geofence charging area; and
communications hardware configured to:
receive an exit power level indication of the EV in response to the EV exiting the geofence charging area,
receive an updated power consumption rate of the EV in response to the EV exiting the geofence charging area, and
receive an updated self-charging rate of the EV in response to the EV exiting the geofence charging area.

17. The apparatus of claim 10, further comprising communications hardware configured to:
cause transmission to the EV of the charging transaction, wherein the charging transaction is based on the entry token and the exit token,
cause transmission to the EV of one or more available payment options, and receive from the EV a payment option selection indicating at least one of the one or more available payment options.

18. The apparatus of claim 17, wherein the payment transaction circuitry is further configured to:
initiate, based on the payment option selection, a payment of the charging transaction; and
receive a payment confirmation indicating whether the payment of the charging transaction is successful,
wherein the communications hardware is further configured to cause transmission to the EV of the payment confirmation in an instance in which the payment of the charging transaction is successful or a payment failure in an instance in which the payment of the charging transaction is unsuccessful.

19. A computer program product for geofence based electrical vehicle (EV) induction charging, the computer program product comprising at least one non-transitory computer-readable storage medium storing software instructions that, when executed, cause an apparatus to:
identify an EV;
identify a geofence charging area;
generate an entry token for the EV;
cause charging of the EV within the geofence charging area;
generate an exit token for the EV; and
generate a charging transaction for the EV.

20. The computer program product of claim 19, wherein the software instructions, when executed, further cause the apparatus to:
cause transmission of an identification request requesting vehicle parameters for the EV, wherein the vehicle parameters comprise at least one or more of a vehicle identifier, a user account or billable account, a vehicle model, a battery type, a charging mode, a power consumption rate, or a self-charging rate, wherein one or more of the power consumption rate or the self-charging rate are variable based on a travel speed of the EV;
receive the vehicle parameters of the EV;
compare the vehicle parameters with stored vehicle parameters associated with the EV;
determine whether the vehicle parameters of the EV are valid;
cause transmission of a validation notification indicating whether the vehicle parameters are valid and whether an induction charging process is ready to start; and
cause transmission, based on whether the vehicle parameters are valid, of an authorization indication indicating whether to allow or block the induction charging process.
